(19) United States
(12) Patent Application Publication
(10) Pub. No.: US 2004/0117780 A1
(43) Pub. Date: Jun. 17, 2004

(54) Method and system for detecting and resolving unnecessary source module dependencies

(76) Inventors: Brian S. Sea, Harahan, LA (US); Christopher J. Kiick, Plano, TX (US); Jeffrey J. Naset, Richardson, TX (US)

Correspondence Address: HEWLETT-PACKARD COMPANY, Intellectual Property Administration, P.O. Box 272400, Fort Collins, CO, 80527-2400, US

(21) Appl. No.: 10/322,072

(22) Filed: Dec. 17, 2002

(51) Int. Cl. G06F 9/45

(52) U.S. Cl. 717/159; 717/124; 717/140

(57) ABSTRACT

A method and system for detecting and resolving unnecessary source module dependencies is described. One embodiment comprises a method of removing unnecessary preprocessor directives from a source module, wherein each of the preprocessor directives references a header file included in the source module, the method comprising removing from the source module a designated header file, subsequent to the removing, attempting to compile the source module, and responsive to a successful attempt to compile the source file, deeming the designated header file unnecessary.

### BACKGROUND

There are several major problems inherent in the maintenance of large computer software source file, or module, bases. For example, as source bases evolve, explicit dependencies between modules are seldom removed, as validating each such removal is a difficult and tedious process to perform manually. The presence of extraneous explicit dependencies can cause build tools initiate unnecessary rebuilds of previously compiled modules, wasting time and storage. Additionally, an explicit dependency will sometimes be forgotten or overlooked because an implicit, or transitive, dependency enables a source module to compile without error. In such cases, unrelated changes in the source base can cause such a source module to fail to compile in the event the transitive dependency is modified.

Previous tools for solving the above-described problems suffered certain deficiencies, including failure to locate missing explicit dependencies in the presence of transitive dependencies and erroneous removal of required explicit dependencies in the presence of transitive dependencies.

A related problem exists particularly with respect to C source modules that have been developed over an extended period of time and have therefore likely been extensively modified. Such files tend to accumulate “include” (or “import”) preprocessor directives as they age. The form of such an “include” directive is #include (or #import) followed by the name of a file, commonly called a header file or an include file (e.g., #include <filename>). Hereinafter, use of “include” and “#include” in connection with preprocessor directives will be deemed to also include “import” and “#import” and other equivalents. Files referenced by the “include” preprocessor directive are typically header files, having an “.h” suffix. An “include” preprocessor directive is used to switch compiler input to the designated header file. In many cases, at least some of the #include directives are no longer necessary; in some cases, they were never needed in the first place, but were merely copied into the source module from another source module.

The inclusion of unnecessary header files via #include directives unnecessarily increases the time it takes to compile the source code, as well as the interdependency of the source code. Additionally, it negatively impacts the modularity of the source code and causes patches to the source code to be unnecessarily large. All of the foregoing conditions can be improved by removing unnecessary #include directives, and hence unnecessary header files, from a C language source module.

No tool currently exists that will detect the unnecessary inclusion of header files in a C language source module via “include” directives. In particular, C compilers, preprocessors, and other currently available software development and diagnostic tools fail to detect this condition. Previous methods of detecting the inclusion of unnecessary header files fail to detect the case in which a header file is included multiple times in an indirect manner. In such cases, simply removing an #include directive designating a header file yields false results if the header file designated by the removed #include directive is included indirectly by another header file.

As previously indicated, C preprocessors fail to delete or avoid inclusion of a header file that is not actually used by the source module being processed. C compilers, which operate after the preprocessor, also have no way of detecting this condition. The only currently available method is to manually inspect the source code and header files that it includes to see if the header file is needed. This process is tedious, labor-intensive and error-prone, and therefore undesirable.

### SUMMARY

In one embodiment, the invention is directed to a method of removing unnecessary preprocessor directives from a source module, wherein each of the preprocessor directives references a header file included in the source module, the method comprising removing from the source module a designated header file, subsequent to the removing, attempting to compile the source module, and responsive to a successful attempt to compile the source module, deeming the designated header file unnecessary.

### BRIEF DESCRIPTION OF THE DRAWINGS

FIG. 1 is a block diagram of a system for rectifying source module dependencies in accordance with one embodiment;

FIG. 2 is a flowchart illustrating operation of the system of FIG. 1;

FIG. 3 is a block diagram of a system for rectifying source module dependencies in accordance with an alternative embodiment;

FIG. 4 is a flowchart illustrating operation of the system of FIG. 3;

FIG. 5 is a block diagram of a system for rectifying source module dependencies in accordance with another alternative embodiment;

FIG. 6 is a flowchart illustrating operation of the system of FIG. 5; and

FIG. 7 illustrates a “depth-first” search technique employed in accordance with the systems of FIGS. 3 and 5.

### DETAILED DESCRIPTION OF THE DRAWINGS

In the drawings, like or similar elements are designated with identical reference numerals throughout the several views thereof, and the various elements depicted are not necessarily drawn to scale.

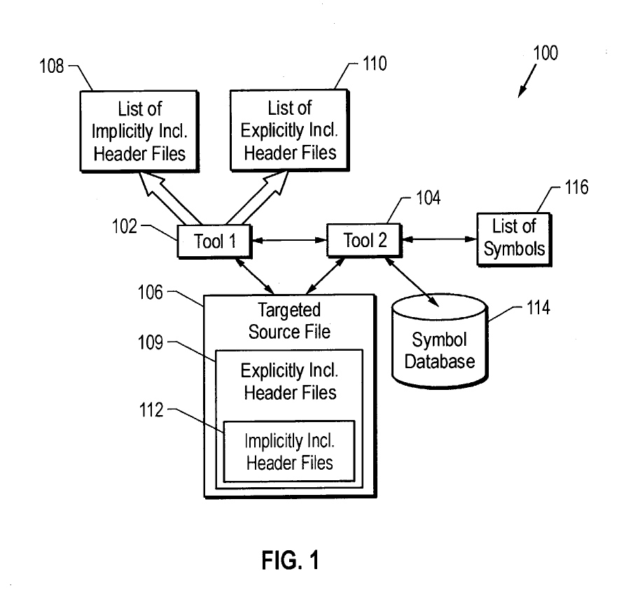

FIG. 1 illustrates a system 100 for rectifying source module dependencies in accordance with one embodiment. As shown in FIG. 1, the system 100 includes a first tool 102 and a second tool 104. The first tool 102 identifies all of the #include directives in a targeted source module, or file, 106 and assembles a list 110 of all of the header files 109 explicitly included by such directives. In other words, the list 110 comprises a list of header files explicitly included in the source module 106.

The tool 102 then identifies the “include” directives in each of the explicitly included header files 109 and creates a list 108 of all of the header files 112 included by such directives. Accordingly, the list 108 comprises a list of header files implicitly, or transitively, included in the source module 106. In one embodiment, the tool 102 may be implemented using a C preprocessor.

The second tool 104 identifies all of the symbols in all of the header files 109, 112, explicitly or implicitly included in the source module 106 and creates therefrom an index or searchable database 114. The database 114 is indexed by symbol and each entry in the database includes the symbol and the header file in which it is defined. The tool 104 then looks up each symbol referenced in the source module 106 in the database 114 and marks the corresponding one of the header files 109, 112.

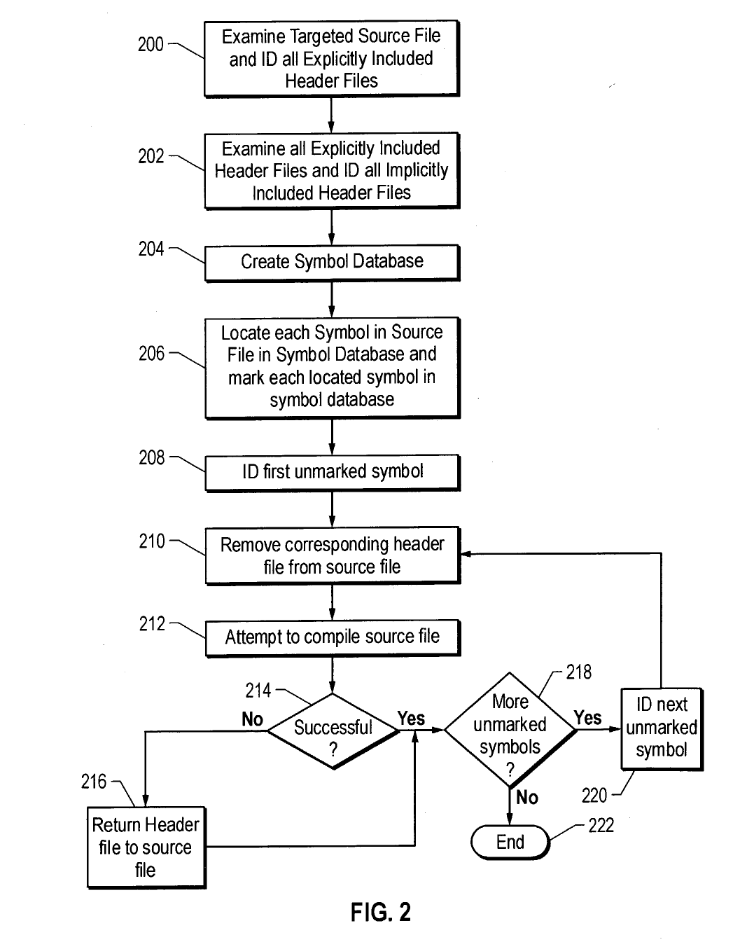

Upon completion of this process for each of the symbols in the source module 106, for each one of the header file 109, 112, that has not been marked, the header file is removed from the source module 106 and an attempt is made to compile the source module without the removed header file. If the attempt fails, the removed header file is deemed necessary and returned to the source module 106. If the file 106 compiles properly without the removed header file, then the #include directive that includes the header file in the source module 106 is removed therefrom (thereby removing the header file from the source module). Alternatively, the header file may be marked as unnecessary and returned to the source module 106, with all of the “unnecessary” header files being removed after all of the files have been removed individually. In any case, the process of removing and compiling is repeated individually for each unmarked header file. This process will be described in greater detail below with reference to FIG. 2. The second tool 104 may be implemented using a parser/indexer tool, such as Cscope, which is a developers' tool for browsing source code.

FIG. 2 is a flowchart illustrating operation of the system 100 of FIG. 1. In block 200, a targeted source module is examined and all of the header files explicitly included therein are identified. In block 202, each of the header files identified in block 200 are examined and all of the header files implicitly included in one or more of those files are identified. The process described in block 202 is a recursive process and is repeated until no more new header files are identified. In block 204, a searchable database is created that includes all of the symbols defined in any of the header files identified in blocks 200 and 202. The database is indexed by symbol and each entry thereof identifies a symbol and the header file in which the symbol is defined. In block 206, each symbol referenced in the source module is located in the database and the corresponding entry is marked. Alternatively, or additionally, the header file in which the symbol is defined (as indicated in the database entry) is marked. In block 208, a first unmarked header file (or the header file identified in the first unmarked entry of the database) is identified. In block 210, the identified header file is removed from the source module, e.g., by removing the #include directive that includes the header file. In block 212, an attempt is made to compile the source module without the header file removed in block 210. In block 214, a determination is made whether the attempt was successful. If not, execution proceeds to block 216, in which the header file is returned to the source module (e.g., by replacing the #include directive), and then to block 218. Otherwise, execution proceeds directly to block 218 and the header file remains omitted from the source module.

In block 218, a determination is made whether there are any more unmarked header files. If so, execution proceeds to block 220, in which the next unmarked header file is identified, and then returns to block 210; otherwise, execution terminates in block 222.

It should be noted that, as an alternative response to a positive determination in block 214, rather than leaving the unmarked header file out of the targeted source module at this point, the header file may be tagged as unnecessary and returned to the targeted source module prior to proceeding to block 218. In this scenario, upon a negative determination in block 218, all of the header files tagged as unnecessary would be removed at the same time prior to termination of the process in step 222.

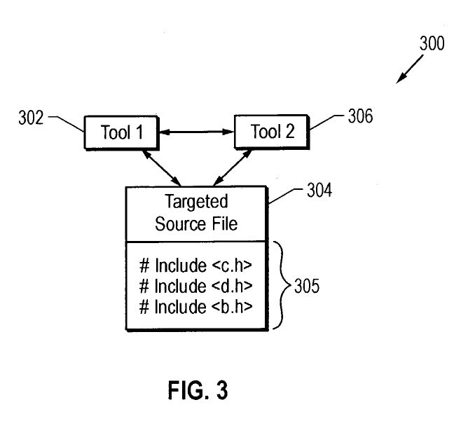

FIG. 3 illustrates a system 300 for rectifying source module dependencies in accordance with an alternative embodiment. In the system 300, a first tool 302, comprising, for example, a specialized parser/indexer, locates all of the#include directives 305 within a targeted source module 304. A second tool 306, comprising, for example, a script, removes each #include directive one at a time and attempts to compile the source module 304 without the missing #include directive. If the source module 304 compiles successfully, the removed #include directive is not needed. The process is repeated for each of the #include directives 305 identified by the first tool 302 one at a time.

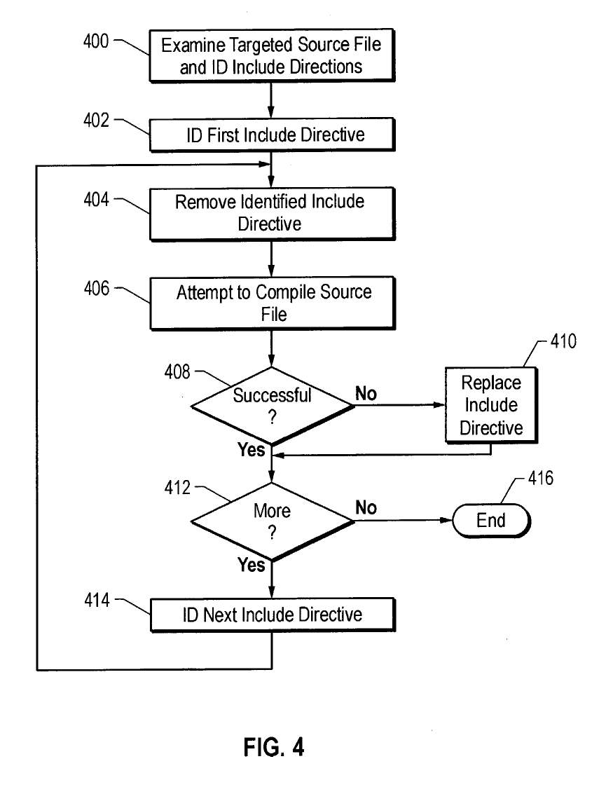

FIG. 4 is a flowchart of the operation of the system 300 of FIG. 3. In block 400, a targeted source module is examined and all of the #include directives included therewithin are located. In block 402, a first one of the #include directives is identified. In block 404, the identified #include directive is removed from the targeted source module. In block 406, an attempt is made to compile the targeted source module without the removed #include directive. In block 408, a determination is made whether the attempt was successful. If not, execution proceeds to block 410, in which the #include directive is returned to the source module, and then to block 412. Otherwise, execution proceeds directly to block 412 and the #include directive remains omitted from the targeted source module.

In block 412, a determination is made whether there are any more #include directives. If so, execution proceeds to block 414, in which the next #include directive is identified, and then returns to block 404; otherwise, execution terminates in block 416.

It should be noted that, as an alternative response to a positive determination in block 408, rather than leaving the unmarked header file out of the targeted source module at this point, the header file may be tagged as unnecessary and returned to the targeted source module prior to proceeding to block 412. In this scenario, upon a negative determination in block 412, all of the header files tagged as unnecessary would be removed at the same time prior to termination of the process in step 416.

It will be recognized that there may be situations in which a header file is both explicitly and implicitly included in a targeted source module. Assume, for example, that the targeted source module includes header files A.h, B.h and C.h, and that the header file C.h includes the header file B.h. When the “include” directive “#include <B.h>” is removed from the targeted source module and an attempt is made to compile the targeted source module, the attempt will succeed regardless of whether B.h is necessary because the reference to B.h has not been removed; rather, it has been “hidden” in C.h.

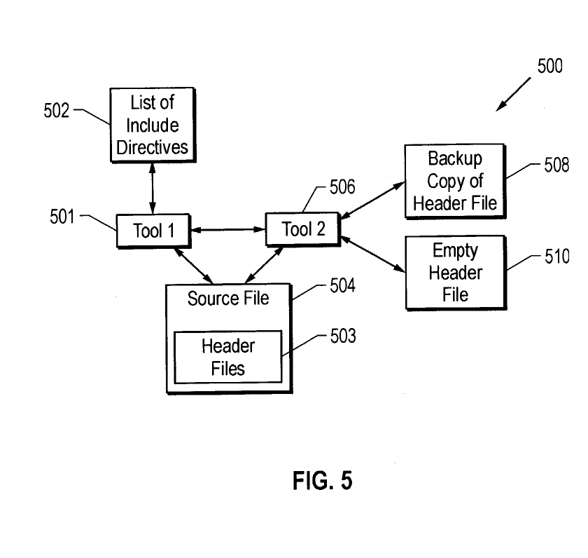

Accordingly, FIG. 5 illustrates a system 500 for rectifying source module dependencies in accordance with another alternative embodiment. As shown in FIG. 5, the system 500 includes a first tool 501 for compiling a list of #include directives 502 relating to header files 503 included in a targeted source module 504. A second tool 506 makes a backup copy of each header file 503, as represented in FIG. 5 by a backup header file 508, and, one file at a time, renders the original copy of the header file empty, as represented in FIG. 5 by an empty header file 510. An attempt is then made to compile the source module 504 using the empty header file 510.

If the source module 504 compiles successfully, meaning the header file is not necessary, the header file is removed from the targeted source module 504; i.e., by removing the corresponding #include directive. If the targeted source module 504 depends on symbols that are included, either explicitly or implicitly (i.e., by an #include directive), in the header file, the attempt to compile the source module 504 will fail. In this manner, the system 500 addresses the issue presented in the example described above with respect to explicit versus implicit inclusion.

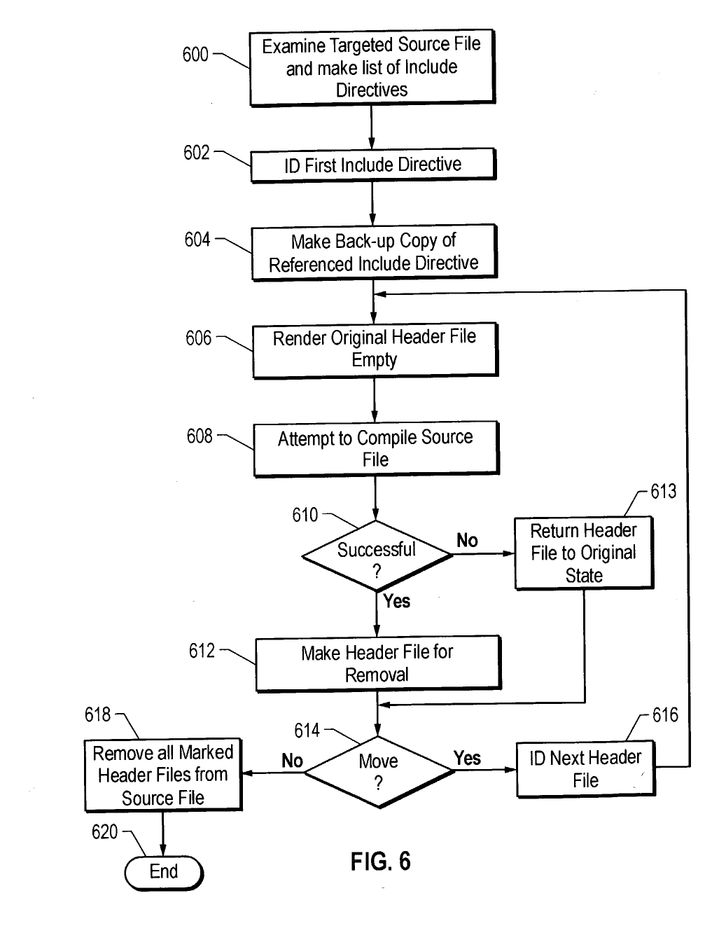

FIG. 6 is a flowchart of the operation of the system 500. In block 600, a targeted source module is examined and a list is made of all of the #include directives included therewithin. In block 602, the first #include directive is identified. In block 604, a backup of the header file referenced by the identified #include directive is made. In block 606, the original (non-backup) copy of the header file is made empty. Steps 604 and 606 can be accomplished in numerous ways. For example, an empty file can be written over the non-backup copy and the back-up copy subsequently written thereover (block 613 below). Alternatively, the preprocessor can be “tricked” via a command line option, or otherwise specified option, adding another directory to search for header files before the standard search directories. This added directory would contain an empty header file.

In any case, in block 608, an attempt is made to compile the targeted source module using the empty copy of the identified header file. In block 610, a determination is made whether the attempt was successful. If so, execution proceeds to block 612, in which the identified #include file is marked for removal. Otherwise, execution proceeds to block 613, in which the empty copy of the header file is replaced with the original contents thereof.

Upon completion of block 612 or block 613, execution proceeds to block 614, in which a determination is made whether there are any more #include directives in the list. If so, execution proceeds to block 616, in which the next #include directive in the list is identified, and then returns to block 614. Otherwise, in block 618, all of the #include directives marked for removal are removed from the targeted source module (e.g., by removing the #include directives corresponding thereto) and execution terminates in block 620.

It should be noted that, as an alternative response to a positive determination in block 610, rather than simply marking the identified header file for removal in block 612, the identified header file could be removed immediately, e.g., by removing the #include directive corresponding thereto in block 612 and omitting the other operations described in that block. In this scenario, the operations described in block 618 would be omitted and execution would proceed directly to block 620 responsive to a negative determination in block 614.

With reference to the alternative embodiments illustrated in FIGS. 3-6, it will be recognized that the order in which the header files are removed from the source module and an attempt made to compile the source module is important because there may be dependencies among the header files. For example, assuming that a file D includes a header file C, a file that includes the file D cannot be compiled unless it also includes the file C, because the file D uses symbols defined in file C. Accordingly, if a source module includes the file D, it must also include the file C, whether or not anything in file C is used directly by the source module. If it turns out that the inclusion of the file D in the source module is unnecessary, then both files C and D should be removed; otherwise, neither D nor C should be removed.

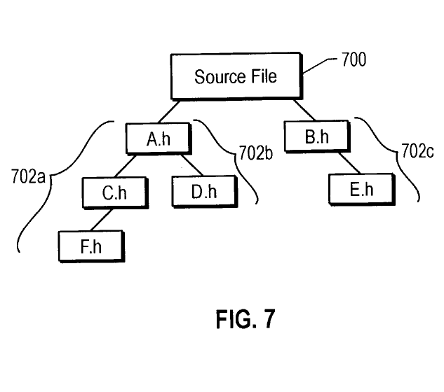

In view of the foregoing, it is proposed that header files are properly tested and subsequently removed, if so dictated, in a “depth-first” order. This will be illustrated in FIG. 7 following example in which a source module 700 includes header files A.h and B.h, the header file A.h includes header files C.h and D.h, the header file B.h includes header file E.h, and the header file C.h includes header file F.h. Accordingly, the “tree” comprising the hierarchy of file dependencies for the source module 700 includes three “branches” 702a-702c. The files comprising each branch are removed (and a subsequent attempt made to compile the source module 700) in order from bottom to top. For example, for the branch 702a, the file F.h is removed first, the file C.h is removed next, and the file A.h is removed last.

It should be noted that, although exemplary embodiments of the invention have been described as being implemented in a C language environment using a C language compiler and preprocessor, other types source code languages and corresponding compilers/preprocessors, such as Java and Perl, for example, may also be employed without departing from the spirit or scope of the invention.

What is claimed is:

1. A method of removing unnecessary preprocessor directives from a source module, wherein each of the preprocessor directives references a header file included in the source module, the method comprising:
removing from the source module a designated header file;
subsequent to the removing, attempting to compile the source module; and
responsive to a successful attempt to compile the source file, deeming the designated header file unnecessary.

2. The method of claim 1 further comprising, responsive to an unsuccessful attempt to compile the source module, returning the designated header file to the source module.

3. The method of claim 2 wherein the deeming further comprises marking the designated header file unnecessary and returning the designated header file to the source module.

4. The method of claim 3 further comprising repeating the removing, attempting, and returning or marking for each header file included in the source module.

5. The method of claim 4 further comprising removing from the source module all header files marked unnecessary.

6. The method of claim 1 wherein the removing comprises removing a preprocessor directive that references the designated header file.

7. A method of removing unnecessary preprocessor directives from a source module, wherein each of the preprocessor directives references a header file included in the source module, the method comprising:
rendering a designated header file empty;
subsequent to the rendering, attempting to compile the source module; and
responsive to a successful attempt to compile the source file, deeming the designated header file unnecessary.

8. The method of claim 7 further comprising, responsive to an unsuccessful attempt to compile the source module, returning the designated header file to its original form.

9. The method of claim 8 wherein the deeming further comprises marking the designated header file unnecessary and returning the designated header file to its original form.

10. The method of claim 9 further comprising repeating the rendering, attempting, and returning or marking for each header file included in the source module.

11. The method of claim 10 further comprising removing from the source module all header files marked unnecessary.

12. The method of claim 11 wherein the removing comprises removing a preprocessor directive that references the designated header file.

13. The method of claim 7 wherein the rendering the designated header file empty comprises:
making a backup copy of the designated header file; and
writing an empty file to the designated header file.

14. The method of claim 13 wherein the returning comprises writing the backup copy of the designated header file to the designated header file.

15. A method of removing unnecessary preprocessor directives from a source module, wherein each of the preprocessor directives references a header file included in the source module, the method comprising:
creating a symbol database comprising every symbol defined in a header file included in the source module, each entry in the symbol database comprising a symbol and the header file in which that symbol is defined;
identifying a symbol in the symbol database that is not referenced in the source module;
removing from the source module the header file in which the identified symbol is defined;
subsequent to the removing, attempting to compile the source module; and
responsive to a successful attempt to compile the source module, deeming the header file in which the identified symbol is defined unnecessary.

16. The method of claim 15 further comprising, responsive to an unsuccessful attempt to compile the source module, returning the header file in which the identified symbol is defined to the source module.

17. The method of claim 15 wherein the deeming further comprises marking the header file in which the identified symbol is defined unnecessary and returning the header file in which the identified symbol is defined to the source module.

18. The method of claim 17 further comprising repeating the removing, attempting, and deeming or returning for all symbols in the symbol database.

19. The method of claim 18 further comprising removing from the source module all header files marked unnecessary.

20. The method of claim 15 wherein the removing comprises removing a preprocessor directive that references the header file in which the symbol is defined from the source module.

21. The method of claim 15 wherein the creating operation comprises:
creating a first list including all symbols defined in header files explicitly included in the source module; and
creating a second list including all symbols defined in header files implicitly included in the source module,
wherein the symbol database includes all symbols included in the first list and all symbols included in the second list.

22. A system for removing unnecessary preprocessor directives from a source module, wherein each of the preprocessor directives references a header file included in the source module, the system comprising:
means for removing from the source module a designated header file;
means for attempting to compile the source module subsequent to the removing; and
means responsive to a successful attempt to compile the source module for deeming the designated header file unnecessary.

23. The system of claim 22 further comprising means responsive to an unsuccessful attempt to compile the source module for returning the designated header file to the source module.

24. The system of claim 23 wherein the means for deeming further comprises means for marking the designated header file unnecessary and returning the designated header file to the source module.

25. The system of claim 24 further comprising means for repeating the removing, attempting, and returning or marking for each header file included in the source module.

26. The system of claim 25 further comprising means for removing from the source module all header files marked unnecessary.

27. The system of claim 22 wherein the means for removing comprises means for removing a preprocessor directive that references the designated header file.

28. A system for removing unnecessary preprocessor directives from a source module, wherein each of the preprocessor directives references a header file included in the source module, the system comprising:
means for rendering a designated header file empty;
means for attempting to compile the source module subsequent to the rendering; and
means responsive to a successful attempt to compile the source module for deeming the designated header file unnecessary.

29. The system of claim 28 further comprising, means responsive to an unsuccessful attempt to compile the source module for returning the designated header file to its original form.

30. The system of claim 29 wherein the means for deeming further comprises means for marking the designated header file unnecessary and returning the designated header file to its original form.

31. The system of claim 30 further comprising means for repeating the rendering, attempting, and returning or marking for each header file included in the source module.

32. The system of claim 31 further comprising means for removing from the source module all header files marked unnecessary.

33. The system of claim 32 wherein the means for removing comprises means for removing a preprocessor directive that references the designated header file.

34. The system of claim 28 wherein the means for rendering the designated header file empty comprises:
means for making a backup copy of the designated header file; and
means for writing an empty file to the designated header file.

35. The system of claim 34 wherein the means for returning comprises means for writing the backup copy of the designated header file to the designated header file.

36. A system for removing unnecessary preprocessor directives from a source module, wherein each of the preprocessor directives references a header file included in the source module, the system comprising:
means for creating a symbol database comprising every symbol defined in a header file included in the source module, each entry in the symbol database comprising a symbol and the header file in which that symbol is defined;
means for identifying a symbol in the symbol database that is not referenced in the source module;
means for removing from the source module the header file in which the identified symbol is defined;
means for attempting to compile the source module subsequent to the removing; and
means responsive to a successful attempt to compile the source module for deeming the header file in which the identified symbol is defined unnecessary.

37. The system of claim 36 further comprising means responsive to an unsuccessful attempt to compile the source module for returning the header file in which the identified symbol is defined to the source module.

38. The system of claim 36 wherein the deeming further comprises means for marking the header file in which the identified symbol is defined unnecessary and returning the header file in which the identified symbol is defined to the source module.

39. The system of claim 38 further comprising means for repeating the removing, attempting, and deeming or returning for all symbols in the symbol database.

40. The system of claim 39 further comprising means for removing from the source module all header files marked unnecessary.

41. The system of claim 36 wherein the means for removing comprises means for removing a preprocessor directive that references the header file in which the symbol is defined from the source module.

42. The system of claim 36 wherein the means for creating comprises:
means for creating a first list including all symbols defined in header files explicitly included in the source module; and
means for creating a second list including all symbols defined in header files implicitly included in the source module,
wherein the symbol database includes all symbols included in the first list and all symbols included in the second list.

43. A computer-readable medium operable with a computer to remove unnecessary preprocessor directives from a source module, wherein each of the preprocessor directives references a header file included in the source module, the medium having stored thereon:
computer-executable instructions for removing from the source module a designated header file;
computer-executable instructions for attempting to compile the source module subsequent to the removing; and
computer-executable instructions for deeming the designated header file unnecessary responsive to a successful attempt to compile the source file.

44. A computer system comprising:
an operating system (“OS”) operable with a computer program environment to remove unnecessary preprocessor directives from a source module, wherein each of the preprocessor directives references a header file included in the source module;
instructions associated with the computer program environment for removing from the source module a designated header file;
instructions associated with the computer program environment for attempting to compile the source module subsequent to the removing; and
instructions associated with the computer program environment for deeming the designated header file unnecessary responsive to a successful attempt to compile the source file.

45. A computer-readable medium operable with a computer to remove unnecessary preprocessor directives from a source module, wherein each of the preprocessor directives references a header file included in the source module, the medium having stored thereon:
computer-executable instructions for rendering a designated header file empty;
computer-executable instructions for attempting to compile the source module subsequent to the rendering; and
computer-executable instructions for deeming the designated header file unnecessary responsive to a successful attempt to compile the source file.

46. A computer-readable medium operable with a computer to remove unnecessary preprocessor directives from a source module, wherein each of the preprocessor directives references a header file included in the source module, the medium having stored thereon:
computer-executable instructions for creating a symbol database comprising every symbol defined in a header file included in the source module, each entry in the symbol database comprising a symbol and the header file in which that symbol is defined;
computer-executable instructions for identifying a symbol in the symbol database that is not referenced in the source module;
computer-executable instructions for removing from the source module the header file in which the identified symbol is defined;
computer-executable instructions for attempting to compile the source module subsequent to the removing; and
computer-executable instructions for deeming the header file in which the identified symbol is defined unnecessary, the instructions operating responsive to a successful attempt to compile the source module.
